(19) United States
(12) Patent Application Publication
(10) Pub. No.: US 2026/0252412 A1
(43) Pub. Date: Aug. 27, 2026

(54) DELEGATING DATA PROCESSING TASKS

(71) Applicant: Arm Limited, Cambridge (GB)

(72) Inventors: Robert Gwilym DIMOND, Cambridge (GB); Mbou EYOLE, Soham (GB); Carlos GARCIA-TOBIN, Ely (GB); Thomas Philip SPEIER, Wake Forest, NC (US)

(21) Appl. No.: 19/063,446

(22) Filed: Feb. 26, 2025

(51) Int. Cl. G06F 9/52

(52) U.S. Cl. CPC G06F 9/52

(57) ABSTRACT

Apparatuses, methods, systems, chip-containing products and computer-readable storage media are disclosed. Data processing circuitry performs first data processing operations and second data processing operations. The first data processing operations comprise a first delegation action that signals a first delegated task to be performed by the second data processing operations. Performance of the first delegated task by the second data processing operations comprises a second delegation action, that causes extension processing circuitry to perform a second delegated task asynchronously to the second data processing operations performed by the data processing circuitry. Completion of the first delegated task by the second data processing operations is signalled to the first data processing operations providing a data item with an associated indicator set. The set indicator causes the first data processing operations, when a delegated-task-related data processing operation that depends on the data item is to be performed, to clear the indicator and to perform a synchronization of the data processing circuitry with a result of the second delegated task before performing the delegated-task-related data processing operation.

### TECHNICAL FIELD

The present disclosure relates to data processing. In particular, the present disclosure relates to delegating data processing tasks.

### DESCRIPTION

A data processing apparatus comprising data processing circuitry may be provided with associated extension processing circuitry to which the data processing circuitry can delegate certain data processing tasks. Where the extension processing circuitry operates independently of the data processing circuitry, delegated tasks are performed task asynchronously to the data processing operations performed by the data processing circuitry.

### SUMMARY

In one example embodiment described herein there is an apparatus comprising:
data processing circuitry configured to perform first data processing operations and second data processing operations,
wherein the first data processing operations comprise a first delegation action, wherein the first delegation action is arranged to signal a first delegated task to be performed by the second data processing operations,
and wherein performance of the first delegated task by the second data processing operations comprises a second delegation action; and
extension processing circuitry associated with the data processing circuitry and configured to perform a second delegated task in response to the second delegation action, wherein the extension processing circuitry is configured to perform the second delegated task asynchronously to the second data processing operations performed by the data processing circuitry,
wherein the second data processing operations are arranged to signal completion of the first delegated task to the first data processing operations and to provide a data item, wherein an indicator associated with the data item is set,
wherein the first data processing operations are arranged, when a delegated-task-related data processing operation that depends on the data item is to be performed, and when the indicator is set, to clear the indicator and to perform a synchronization operation that synchronizes the data processing circuitry with a result of the second delegated task before performing the delegated-task-related data processing operation.

In one example embodiment described herein there is a system comprising:
the apparatus outlined above, implemented in at least one packaged chip;
at least one system component; and
a board, wherein the at least one packaged chip and the at least one system component are assembled on the board.

In one example embodiment described herein there is a chip-containing product comprising the system outlined above, wherein the system is assembled on a further board with at least one other product component.

In one example embodiment described herein there is a method comprising:
performing first data processing operations and second data processing operations in data processing circuitry,
wherein the first data processing operations comprise a first delegation action, wherein the first delegation action is arranged to signal a first delegated task to be performed by the second data processing operations,
and wherein performance of the first delegated task by the second data processing operations comprises a second delegation action;
delegating from the second data processing operations a second delegated task to extension processing circuitry associated with the data processing circuitry;
performing the second delegated task delegated by the second data processing operations in the extension processing circuitry, wherein the extension processing circuitry is configured to perform the second delegated task asynchronously to the second data processing operations performed by the data processing circuitry;
signalling completion of the first delegated task by the second data processing operations to the first data processing operations and providing a data item, wherein an indicator associated with the data item is set; and
in the first data processing operations, when a delegated-task-related data processing operation that depends on the data item is to be performed, and when the indicator is set, clearing the indicator and performing a synchronization operation that synchronizes the data processing circuitry with a result of the second delegated task before performing the delegated-task-related data processing operation.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus according to some examples;

FIG. 2 schematically illustrates a data processing apparatus according to some examples;

FIG. 3 schematically illustrates an apparatus in accordance with some examples;

FIG. 4 schematically illustrates an apparatus in accordance with some examples;

FIG. 5 schematically illustrates an apparatus in accordance with some examples;

FIG. 6 schematically illustrates an extension start instruction delegating a task to extension processing circuitry in accordance with some examples;

FIG. 7 schematically illustrates the propagation of a set indicator associated with a data item through further data items that depend directly or indirectly on that data item in accordance with some examples;

FIG. 8 schematically illustrates a register file with 8 individual registers each of which can have an indicator bit set in accordance with some examples;

FIG. 9 schematically illustrates a different example of a register file having 8 individual registers each of which can have multiple indicator bits individually set in association with them in accordance with some examples;

FIG. 10 schematically illustrates a variant on the approach shown with reference to FIGS. 8 and 9, where indicators are shared between subgroups of delegated tasks in accordance with some examples;

FIG. 11 schematically illustrates a data processing apparatus in accordance with some examples;

FIG. 12 shows a flow diagram representing a sequence of steps that are taken in accordance with some examples; and

FIG. 13 illustrates a system and a chip containing product according to some configurations of the present techniques.

### DESCRIPTION OF EXAMPLE EMBODIMENTS

Before discussing the embodiments with reference to the accompanying figures, the following description of embodiments is provided.

In accordance with one example configuration there is provided apparatus comprising:
data processing circuitry configured to perform first data processing operations and second data processing operations,
wherein the first data processing operations comprise a first delegation action, wherein the first delegation action is arranged to signal a first delegated task to be performed by the second data processing operations,
and wherein performance of the first delegated task by the second data processing operations comprises a second delegation action; and
extension processing circuitry associated with the data processing circuitry and configured to perform a second delegated task in response to the second delegation action, wherein the extension processing circuitry is configured to perform the second delegated task asynchronously to the second data processing operations performed by the data processing circuitry,
wherein the second data processing operations are arranged to signal completion of the first delegated task to the first data processing operations and to provide a data item, wherein an indicator associated with the data item is set,
wherein the first data processing operations are arranged, when a delegated-task-related data processing operation that depends on the data item is to be performed, and when the indicator is set, to clear the indicator and to perform a synchronization operation that synchronizes the data processing circuitry with a result of the second delegated task before performing the delegated-task-related data processing operation.

The delegation of tasks in a data processing system is associated with various advantages, for example that a delegated task can be performed by a component which is better suited to (indeed, perhaps explicitly configured for) the task and that the data processing circuitry which delegates the task is itself freed up to continue performing other data processing. However, because of the independence of the performance of the delegated task—it is performed asynchronously to the data processing operations performed by the data processing circuitry—this then requires the result(s) of the delegated task to by synchronised with the operations of the data processing circuitry. The inventors of the present techniques have realised that there are circumstances in which perform such synchronisation can be disruptive in a manner that is not necessary. For example, the synchronisation could be performed as part of the second data processing operations performed by the data processing circuitry, yet parallelism may be lost if the first processing operations (that initiated the second data processing operations) do not interact with the result(s) of the delegated task until some later time point. Another approach to the issue could be to implement a hardware-based hazard checking scheme to trigger the synchronisation if an access is made to specific read/write addresses that fall within a range used by the delegated task, but the hardware cost of this is undesirable. Alternatively, the software defining the first data processing operations and the second data processing operations performed by the data processing circuitry could be re-written, such that the second data processing operations are themselves performed asynchronously to the first data processing operations, and the first data processing operations must then explicitly synchronise the delegated task, but the wholesale revision of software involved is also undesirable.

In this context, the present techniques provide an approach wherein the second data processing operations signal completion of the first delegated task to the first data processing operations, providing a data item and with an indicator associated with the data item being set. This set indicator then serves to carry forward the knowledge that synchronisation will be required and subsequently, when a delegated-task-related data processing operation that depends on the data item is to be performed, the set indicator serves to indicate that the synchronisation is required. The synchronisation between the data processing circuitry and a result of the second delegated task is then performed and the indicator cleared. This allows the synchronisation to be delayed until it is required, avoiding disruption to the other data processing operations being performed that do not require the synchronisation.

The first data processing operations and second data processing operations may take a variety of forms and equally the delegation action of the first data processing operations that signals the first delegated task to be performed by the second data processing operations may also take a variety of forms. In some examples, the first delegation action is a call to a function, wherein the second data processing operations are the function, and wherein a return from the function signals the completion of the first delegated task. In such examples, the data item may be a value returned from the function.

In other examples, the first delegation action comprises storing an indication of the first delegated task to a data storage structure, and the second data processing operations are arranged to retrieve the indication of the first delegated task from the data storage structure. For example this may comprise the use of a storage structure such as a FIFO queue, into which the first data processing operations can place indications of tasks to be performed, and from which the second data processing operation can retrieve those indication in order for those delegated tasks to be performed. In such examples, the second data processing operations are arranged to store the data item to a further data storage structure. The first data processing operations can then, when appropriate, retrieve the data item from the further data structure.

The setting of the indicator associated with the data item may be accomplished in a variety of ways. The association may be direct and implicit, for example where the representation of the data item is extended (e.g. by an additional bit) in order to represent the indicator. The association may also be more indirect, whereby the indicator is held in a separate representation to the data item, but the association between that indicator representation and the data item representation is known. However the indicator is represented, the present techniques further recognise that the dependency of the delegated-task-related data processing operation on the data item may be indirect. For example, the delegated-task-related data processing operation may itself depend on a further data item, which has been generated in dependence on the data item. Accordingly, in order nevertheless to track such dependency, in some examples the data processing circuitry, in performing the first data processing operations, is configured to propagate the set indicator in association with resulting data that depends on the data item.

The synchronisation of the data processing circuitry with the result of the second delegated task need not however be an entirely hardware managed action. Some examples support a flexible approach whereby software can also initiate this action. Accordingly, some examples provide a dedicated instruction to provoke the synchronisation. In such examples, the data processing circuitry is configured to perform the first data processing operations in response to a sequence of instructions that define the first data processing operations, and wherein the data processing circuitry is responsive to a synchronisation instruction to perform the synchronization operation and to clear the indicator.

The present techniques propose alternative examples, whereby in some examples there is a separate indicator bit associated with each task delegated to the extension processing circuitry, whereas in other examples an indicator bit may be associated with only one, or a subset, of the tasks delegated to the extension processing circuitry. In the case of a separate indicator bit for each delegated task, only the results of the relevant delegated task are synchronised and that separate indicator bit is cleared, when the delegated-task-related data processing operation that depends on the relevant data item is to be performed. In the case of a shared indicator bit for more than one delegated task, the results of that set of relevant delegated tasks are synchronised and the shared indicator bit is cleared. The sharing of an indicator bit brings the benefit of reduced additional storage required to hold the indicator bit (instead of holding several), which depending on the particular implementation of these techniques can be traded off against the cost of additional synchronisation actions (that a strictly not necessary) being performed).

Hence in some examples, the data processing circuitry is configured to delegate multiple tasks to the extension processing circuitry via multiple sets of second data processing operations,
wherein the data processing circuitry is configured to maintain, for each of the multiple tasks delegated to the extension processing circuitry, a single indicator, such that a completion of a respective first delegated task that delegated a respective task to the extension processing circuitry provides a respective data item, wherein the single indicator associated with the respective data item is set,
and wherein the data processing circuitry is configured, when a respective delegated-task-related data processing operation that depends on the respective data item is to be performed, and when the single indicator is set, to clear the respective indicator and to perform the synchronization operation that synchronizes the data processing circuitry with respective results of all of the multiple tasks delegated to the extension processing circuitry before performing the respective delegated-task-related data processing operation.

Equally in some examples, the data processing circuitry is configured to delegate multiple tasks to the extension processing circuitry via multiple sets of second data processing operations, and the data processing circuitry is configured to maintain a set of indicators,
wherein a completion of a respective first delegated task that delegated a respective task of the multiple tasks to the extension processing circuitry provides a respective data item, wherein a selected indicator of the set of indicators associated with the respective data item is set,
and wherein the data processing circuitry is configured, when a respective delegated-task-related data processing operation that depends on the respective data item is to be performed, and when the selected indicator is set, to clear the selected indicator and to perform the synchronization operation that synchronizes the data processing circuitry with a respective result of the respective task before performing the respective delegated-task-related data processing operation.

In some examples, a multiplicity of the set of indicators corresponds to a multiplicity of the multiple tasks.

In some examples, a multiplicity of the set of indicators is less than a multiplicity of the multiple tasks, such that a given indicator of the set of indicators corresponds to more than one of the multiple tasks.

In examples in which the set indicator is propagated, the present techniques further recognise that it may be beneficial to limit that propagation, for example when there would be additional hardware configuration cost associated with doing so. Accordingly, in some examples the data processing circuitry is configured, when a predetermined type of data processing operation is to be performed, to clear the indicator and to perform the synchronization operation before performing the predetermined type of data processing operation.

One example of such additional hardware configuration cost could come in the context of data processing operations that interact with a memory system, since the representation of the indicator would then need extending into the representation used in the memory system. This could be undesirably expensive in terms of the modifications required.

Thus, in some examples, the predetermined type of data processing operation comprises storing the data item to a memory location. The interaction with the memory system may also be more indirect, such as in some examples, in which the predetermined type of data processing operation comprises a load from or a store to a memory location derived from the data item.

The data item provided by the completion of the first delegated task may take a variety of forms. In some examples, the data item provided by the completion of the first delegated task is a pointer to data generated by the second delegated task. In some examples, the data item provided by the completion of the first delegated task indicates a size of a block of data generated by the second delegated task. In such cases, further data processing operations carried out by the data processing circuitry may depend on the size of the block of data (or indeed whether the block of data exists at all, i.e. has non-zero size). Accordingly, in some examples the data processing circuitry is configured to perform the delegated-task-related data processing operation subject to a size-limit threshold condition for the size of the block of data being satisfied, and the data processing circuitry is configured to propagate the set indicator through a control flow followed when the size-limit threshold condition is satisfied, and to clear the set indicator and to perform the synchronization operation directly prior to performing the delegated-task-related data processing operation.

The data processing circuitry may be variously configured and the first data processing operations it performs may be carried out in a variety of ways. In some examples, the apparatus is configured as an out-of-order data processing apparatus, in which a sequence of instructions that define its data processing operations are not necessarily executed in the order in which instructions appear in that sequence. Register renaming is a known feature of such out-of-order processing, wherein the apparatus can maintain multiple physical register copies of architectural state registers. Hence in some examples, the data processing circuitry is configured to perform the first data processing operations in response to a sequence of instructions that define the first data processing operations, and the data processing circuitry is configured to perform the first data processing operations out-of-order with respect to an ordering of the sequence of instructions, wherein the data processing circuitry comprises multiple physical rename registers that each can be selectively associated with an individual architectural register, and wherein the data processing circuitry, when the delegated-task-related data processing operation that depends on the data item is to be performed, and when the indicator is set, is configured to clear the indicator in all of the multiple physical rename registers.

In some such examples, the data processing circuitry is responsive to a synchronisation instruction to perform the synchronization operation and to clear the indicator in all of the multiple physical rename registers.

In accordance with one example configuration there is provided a system comprising: the apparatus of any of the above examples, implemented in at least one packaged chip; at least one system component; and a board, wherein the at least one packaged chip and the at least one system component are assembled on the board.

In accordance with one example configuration there is provided a chip-containing product comprising the above example system, wherein the system is assembled on a further board with at least one other product component.

In accordance with one example configuration there is provided a method comprising:
performing first data processing operations and second data processing operations in data processing circuitry,
wherein the first data processing operations comprise a first delegation action, wherein the first delegation action is arranged to signal a first delegated task to be performed by the second data processing operations,
and wherein performance of the first delegated task by the second data processing operations comprises a second delegation action;
delegating from the second data processing operations a second delegated task to extension processing circuitry associated with the data processing circuitry;
performing the second delegated task delegated by the second data processing operations in the extension processing circuitry, wherein the extension processing circuitry is configured to perform the second delegated task asynchronously to the second data processing operations performed by the data processing circuitry;
signalling completion of the first delegated task by the second data processing operations to the first data processing operations and providing a data item, wherein an indicator associated with the data item is set; and
in the first data processing operations, when a delegated-task-related data processing operation that depends on the data item is to be performed, and when the indicator is set, clearing the indicator and performing a synchronization operation that synchronizes the data processing circuitry with a result of the second delegated task before performing the delegated-task-related data processing operation.

Particular embodiments will now be described with reference to the figures.

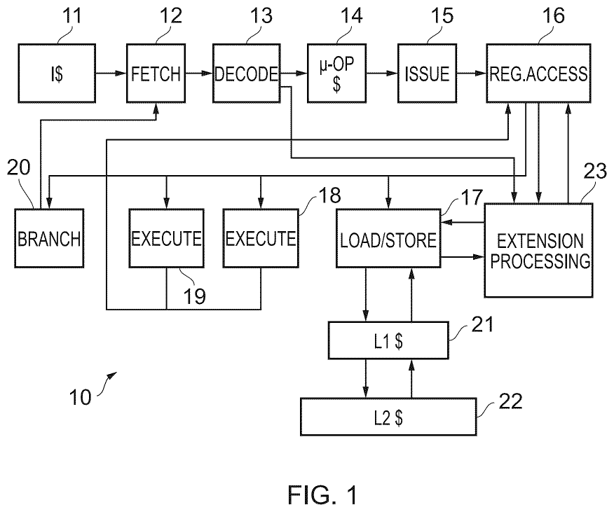

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values that are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to sufficiently frequently used to warrant the provision and configuration of the extension processing circuitry for this purpose. Example functions of this type could include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 may be referred to as an example of a threadlet extension (TE) and the sequence of operations it carries out to perform the defined function may be referred to as a threadlet. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task can be generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task require synchronisation with the set of registers 16. The present disclosure sets out techniques for how and when this synchronisation can be performed.

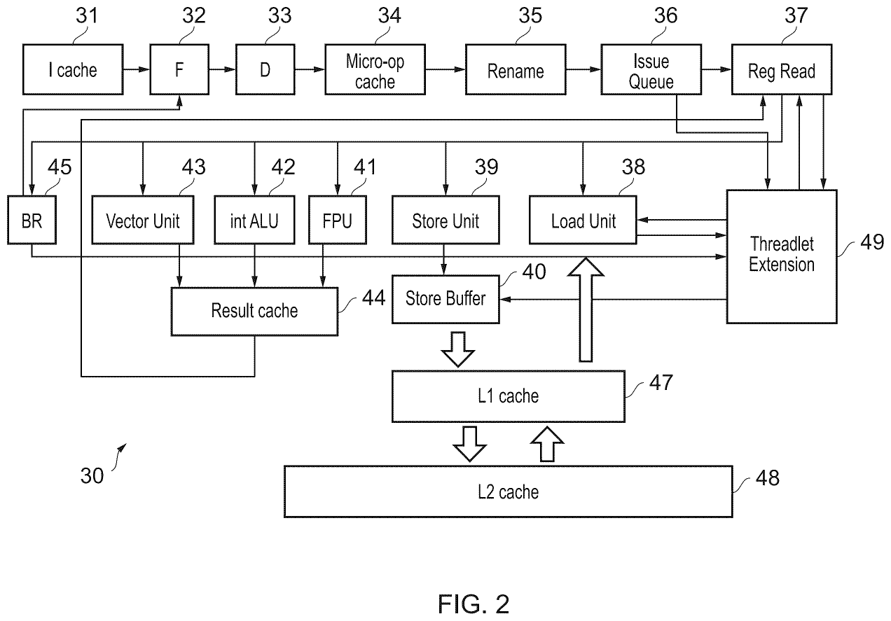

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 represents an in-order processor, the data processing apparatus 30 is an out-of-order processor. As one consequence of this, the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to sufficiently frequently used to warrant the provision and configuration of the extension processing circuitry for this purpose. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task require synchronisation with the set of registers 16. The present disclosure sets out techniques for how and when this synchronisation can be performed.

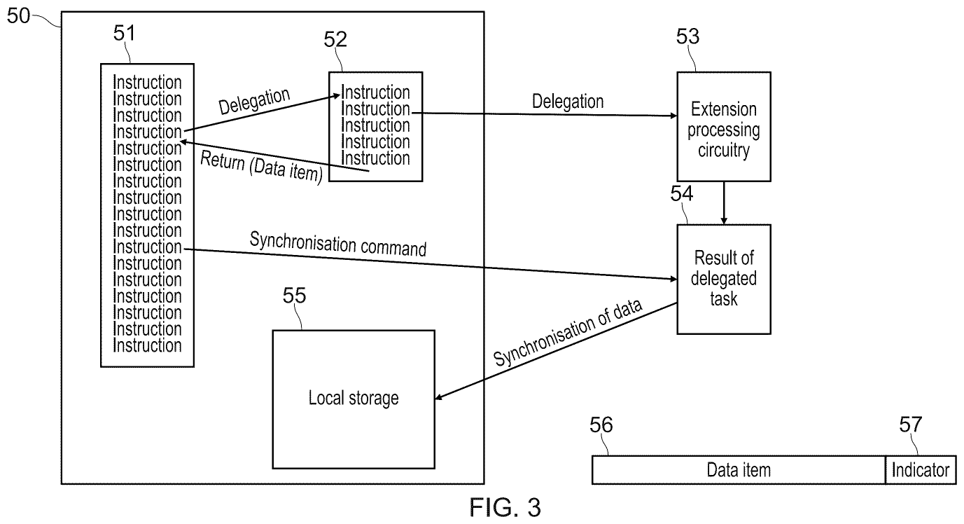

FIG. 3 schematically illustrates an apparatus in accordance with some examples. The apparatus comprises data processing circuitry 50 configured to perform data processing operations. More particularly, the data processing circuitry 50 is configured to perform first data processing operations and second data processing operations, where these are illustrated in the figure as the first sequence of instructions 51 and the second sequence of instructions 52. The first sequence of instructions 51 comprises a delegation action, which signals a first delegated task to be performed by the second data processing operations 52. Thus, when the delegation action is performed as part of the first data processing operations 51, the apparatus switches to performance of the second data processing operations 52 by execution of the second sequence of instructions 52. It will be understood by the person of ordinary skill in the art, comparing FIG. 3 to FIGS. 1 and 2, that the sequences of instructions 51 and 52, when executed by the data processing apparatuses shown, would be fetched by the fetch stages 12, 32 and passed along the respective pipelines for execution. The second sequence of instructions 51 comprises a further delegation action, which signals a second delegated task to the extension processing circuitry 53 associated with the data processing circuitry 50. The extension processing circuitry 53 may be configured to perform a range of tasks, though these will typically be at least restricted to a limited class of tasks, such that the extension processing circuitry can have a configuration that means that it is particularly efficient at performing those tasks. Although perhaps closely associated with the data processing circuitry 50, the extension processing circuitry 53 performs its operations independently of and asynchronously to those of the data processing circuitry 50. Thus the second delegated task performed by the extension processing circuitry is initiated and continues whilst the remainder of the second sequence of instructions 52 is executed. On completion of the second sequence of instructions 52, completion of the first delegated task is signalled to the first data processing operations 51 with the provision of a data item, wherein an indicator associated with that data item is set. The data item may for example be a reference to the data being processed by the extension processing circuitry 53. The setting of the indicator serves to notify to the first data processing operations 51 that a task was delegated to the extension processing circuitry 53 as part of carrying out the second sequence of instructions 52. As a consequence, once the result 54 of the delegated task performed by the extension processing circuitry 53 is complete, synchronisation of this result with the local storage of the data processing circuitry 50 will be required. However the present techniques allow this synchronisation to be delayed until it is actually required, by virtue of the fact that in the continuation of first data processing operations 51 only when a task is to be performed that in some way depends on the data item returned from the second sequence of instructions 52, does the synchronisation need to be performed and the set indicator associated with the data item serves to indicate the requirement for the synchronisation. Thus, in the further performance of the first data processing operations, when a delegated-task-related data processing operation that depends on the data item is to be performed, and when the indicator is set, the indicator is cleared and a synchronization operation is performed that synchronizes the data processing circuitry 50 with a result 54 of the second delegated task before performing the delegated-task-related data processing operation. The synchronisation may comprising retrieving one or more data values as the result 54 of the delegated task and updating the local storage 55 of the data processing circuitry 50 with those one or more data values. An example data item 56 is also shown, with its associated indicator 57. The indicator 57 in this example comprises an additional bit by which the representation of the data item 56 is extended, although in other examples may comprise more than one bit.

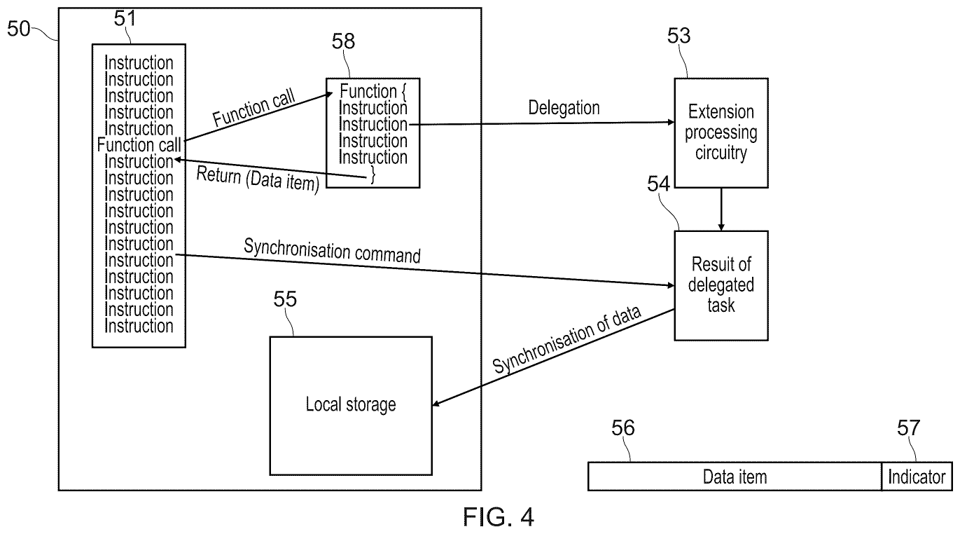

FIG. 4 schematically illustrates an apparatus in accordance with some examples. The apparatus is essentially the same as that illustrated in FIG. 3 and thus comprises the same data processing circuitry 50 and extension processing circuitry 53. FIG. 4 shows a particular example of the delegation process shown in FIG. 3, whereby the delegation action forming part of the first sequence of instructions 51 is a function call, and therefore the second data processing operations 52 are the execution of that function. The function may take a variety of forms, such as a simple function call, a library call, a system call, etc. As part of the second sequence of instructions 58 forming the function, a delegation action invoking the use of the extension processing circuitry 53 occurs. As in the example of FIG. 3, the extension processing circuitry 53 performs its operations independently of and asynchronously to those of the data processing circuitry 50. The return of the function 58 returns a data item 56, and the indicator 57 associated with the data item indicates that the performance of the function 58 has involved the delegation of a task to the extension processing circuitry. The data item may for example be a reference to the data processed by the extension processing circuitry. The synchronisation that is then required between the result of the delegated task 54 and the data processing circuitry 50 can then be carried out only later when required. Note that the synchronisation command that causes this synchronisation to occur can be triggered in various ways, but in some examples the first sequence of instructions 51 comprises a synchronisation instruction which is provided for the explicit purpose of triggering the synchronisation of the result of the extension processing circuitry's actions with the data state of the data processing circuitry.

In another example, the second data processing operations (e.g. the function 58 of FIG. 4) do not return a reference to the data being processed but instead returns a value that must be processed in order to interpret the data correctly. For example, a decompression function takes as input pointers to source and destination buffers, and returns the size of the decompressed data block. The calling code must contemplate that the size of the decompressed block can be zero, so must check the returned size before accessing any of the data in the returned block. In this example, the returned size can have the associated set indicator, and indicator is either consumed when the size value is first checked or, the set indicator is propagated via control flow, so that the first load or store dependent on checking the size value consumes the set indicator and triggers the synchronisation. Note that in this example the synchronisation of the source buffer would need separate handling, to ensure it is not overwritten after the return of the function call. One way this could be achieved is to synchronise reading the compressed input data (for example, into an intermediate buffer) before returning from the function.

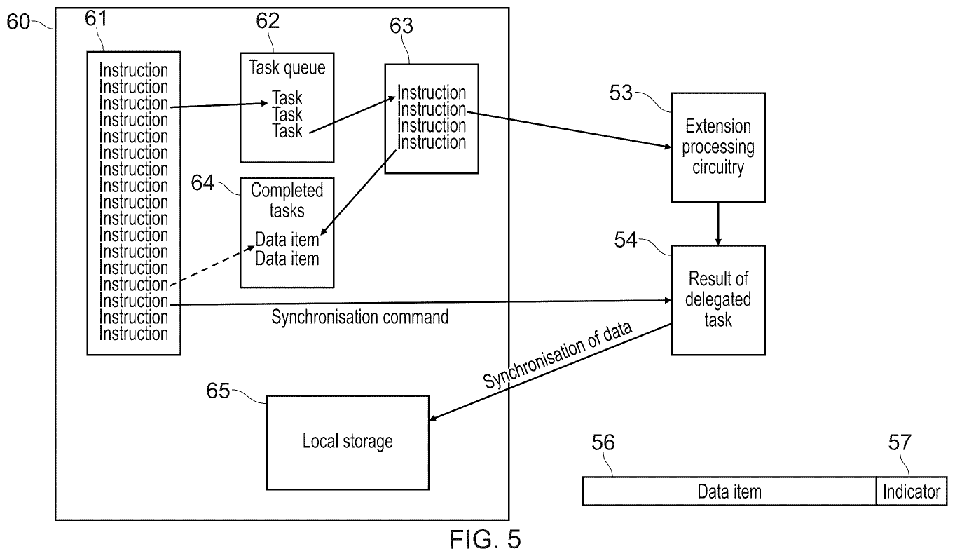

FIG. 5 schematically illustrates an apparatus in accordance with some examples. The apparatus is another variant on that illustrated in FIGS. 3 and 4. In this example, however, the data processing circuitry 60 operates in a slightly different manner, in particular with respect to the delegation process from the first data processing operations. In this example the data processing circuitry 60 comprises a task queue 62, into which the first data processing operations 61 can cause a task indication to be stored. The second data processing operations 63 are arranged to access the task queue 62 to retrieve a task indication stored there and to carry out a corresponding task. The data processing circuitry 60 further comprises a completed task storage 64, into which the second data processing operations 63 can cause data items to be stored, a stored data item being indicative of a corresponding task having been performed by the second data processing operations 63. The performance of the second data processing operations 63 delegates a task to the extension processing circuitry 53 in the same manner as described above with reference to FIGS. 3 and 4. Accordingly, the second data processing operations 63 causes the indicator 57 associated with the data item 56 that it stores in the completed tasks storage 64 to be set, indicating that part of the task queued in the task queue 62 that the second data processing operations 63 performed was delegated to the extension processing circuitry 53. At some later point in the first data processing operations 61, an access to the completed tasks storage 64 is made and the data item 56 stored there by the second data processing operations 63 is retrieved. The presence of the set indicator 57 means that when the first data processing operations 61 need to perform a delegated-task-related data processing operation that depends on the data item 56, the indicator is cleared and a synchronization operation is performed that synchronizes the data processing circuitry 60 with a result 54 task delegated to the extension processing circuity before that delegated-task-related data processing operation is carried out.

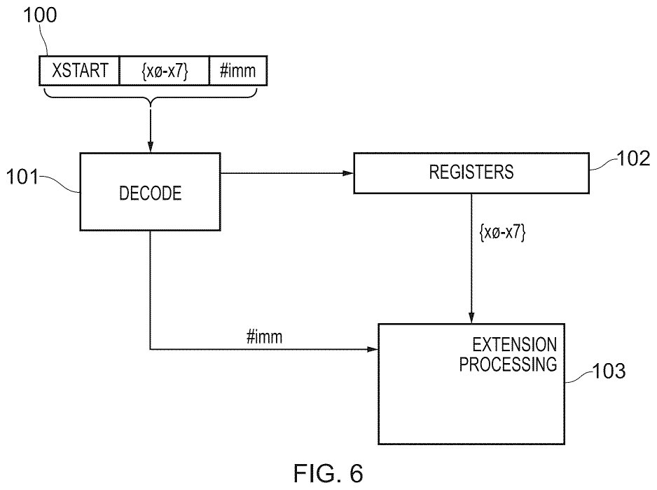

FIG. 6 schematically illustrates an extension start instruction delegating a task to extension processing circuitry in accordance with some examples. This represents an example of how the extension processing circuitry 23, 49 described above with reference to FIGS. 1 and 2, or the extension processing circuitry 53 described above with reference to FIGS. 3-5, may be invoked. Here the XSTART instruction takes the form: XSTART {x0-x7}, #imm. Thus an XSTART instruction 100 of this form, when decoded by the CPU's decoder 101, causes the content of registers x0-x7 to be retrieved from the registers 102 and passed to the extension processing circuitry 103. In this case the extension processing circuitry 103 can perform multiple types of operation (task) and the immediate value #imm (or signals based on the immediate value #imm) selects between them.

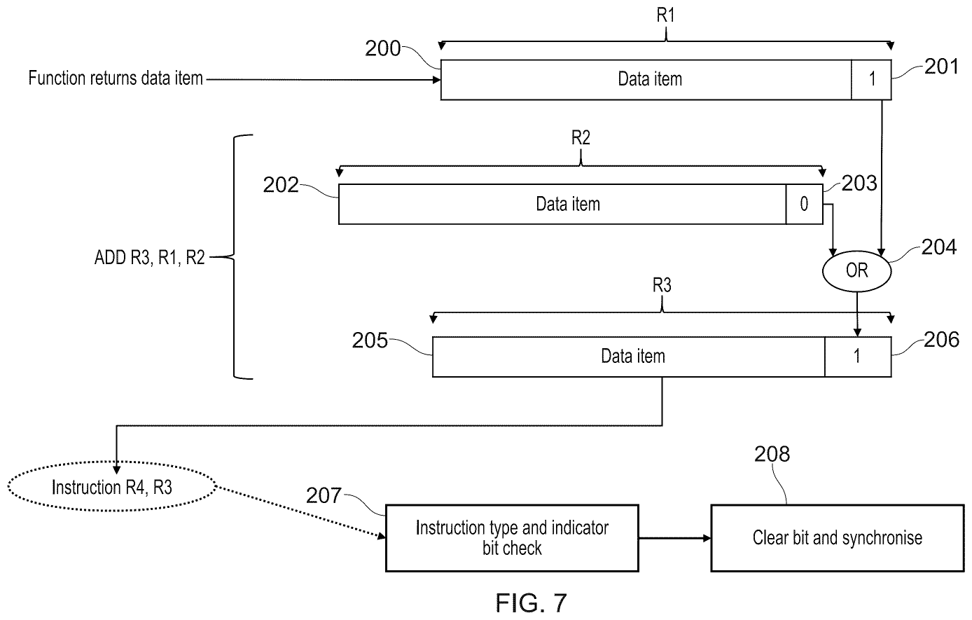

FIG. 7 schematically illustrates the propagation of a set indicator associated with a data item through further data items that depend directly or indirectly on that data item. In this example, a function returns a data item 300 with its indicator 301 set, indicating that the data processing performed by the function was in part delegated to extension processing circuitry operating asynchronously with respect to the data processing circuitry performing the function. This data item 300 is held in a register R1, which in a later step provides a source operand for the instruction ADD R3, R1, R2. In order to propagate the set indicator, the respective indicators 301, 303 associated with the data items 300, 302 held in registers R1, R2 are subjected to an OR function 304, with the result forming the indicator 306 associated with the data item 305 that is generated by the ADD and stored in register R3. Later, a further instruction takes R3 as one of its source operands (Instruction R4, R3). The instruction type and indicator bit are checked 207 and, when the instruction type is one that will require synchronisation when operating on the data value in R3, and the indicator is set, then at 208 the bit is cleared and the synchronisation is triggered. Of course, the sequence of propagation shown in the figure is only one example and other dependencies could also propagate the indicator. The data item returned could for example be a pointer to a buffer of processed data, and there may be arithmetic operation performed on the pointer to offset into the buffer. The result of such an arithmetic operation could also propagate the indicator bit.

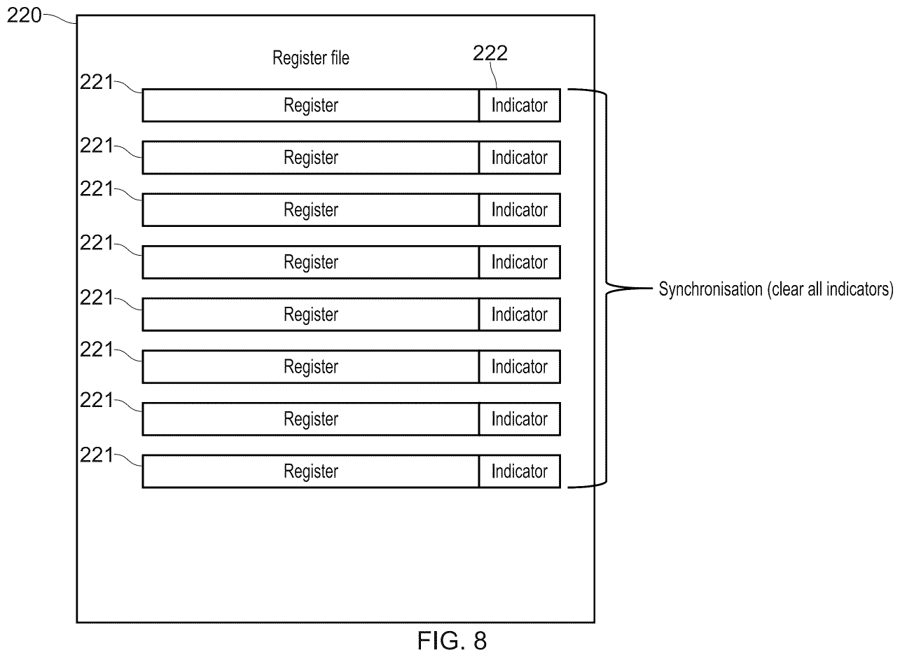

FIG. 8 schematically illustrates a register file 220 having 8 individual registers 221, each of which can have an indicator bit set in association. Although the data processing apparatus which comprises this register file 220 can delegate multiple tasks to extension processing circuitry, there is only one bit associated with each data item in each register. This means that that the indicators do not distinguish between the delegated tasks. Consequently, when a synchronisation is required all indicators are cleared and all tasks delegated to the extension processing circuitry are synchronised. Whilst this means that some synchronisation actions may be carried out earlier than they strictly need to be, it limits the additional storage required to accommodate the indicators to a single bit per data item. The register file 220 can be viewed as a representation of a general-purpose register file in the data processing apparatus. Representing another example, register file 220 can be viewed as a representation of a set of physical rename registers in an out-of-order processor (as in the example of FIG. 2). In such an example, the apparatus maintains the indicator bit as metadata alongside each general-purpose register. Where each general-purpose register maps to multiple physical rename registers, when a synchronisation is to be performed the relevant indicator bit must be cleared from all rename registers to indicate that the synchronisation has already taken place. The synchronisation operation is fractured into multiple micro-operations (one for each general-purpose register), each micro operation clearing the indicator bit from that general-purpose register. Clearing the indicator bit from all rename registers avoids additional hardware that would otherwise be needed to scan all rename registers for the indicator bit, and potentially stalling the CPU pipeline while then scanning is in progress.

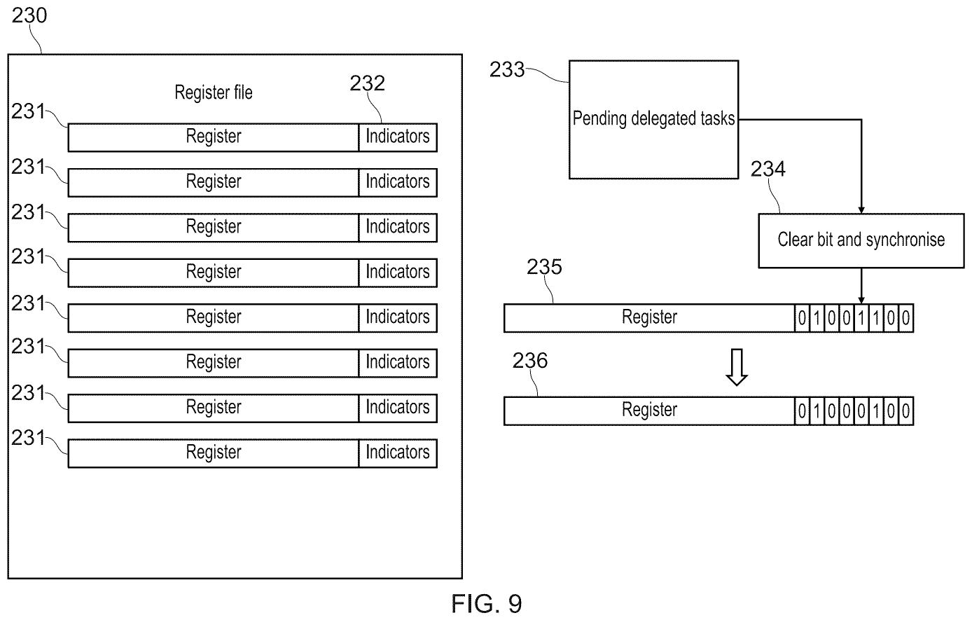

FIG. 9 schematically illustrates a different example of a register file 230 having 8 individual registers 231, each of which can have multiple indicator bits individually set in association with them. In some particular examples of this configuration there can then be as many indicators as there are delegated tasks that can be in flight at any given timepoint. Accordingly, when a data item is used as part of data processing operations in a manner that is delegated-task dependent, a corresponding indicator can be determined by reference to a tracker of delegated tasks 233. Then only the one delegated tasks relevant to the data processing action to be performed needs to be synchronised. The corresponding bit is cleared and the required synchronisation is triggered 234. Thus in the example shown of data item 235, only one indicator bit out of three that are set is identified and cleared, to give the updated data item and set of indicator bits 236.

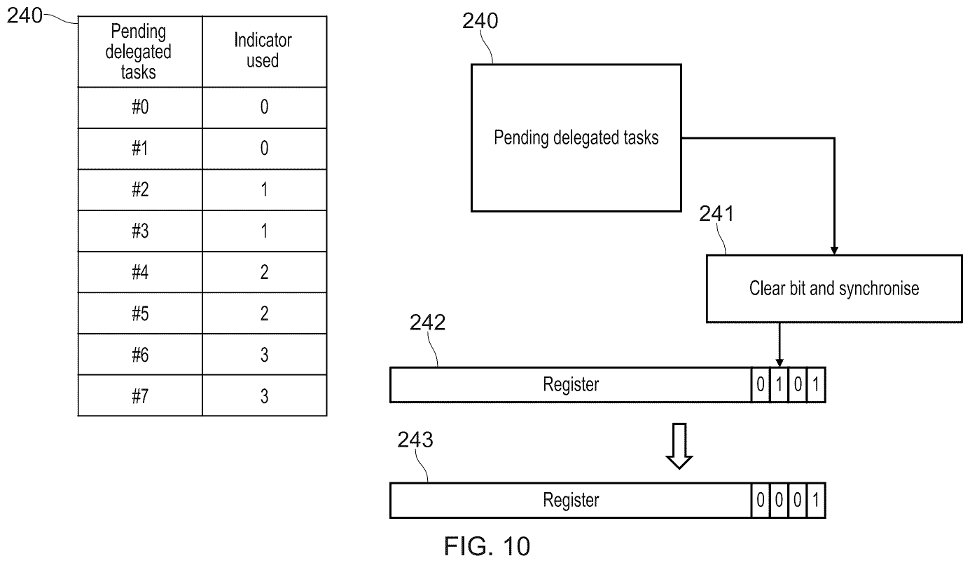

FIG. 10 schematically illustrates a variant on the approach shown with reference to FIGS. 8 and 9, where indicators are shared between subgroups of delegated tasks. As shown in the table of pending delegated tasks 240, this being a record of tasks that have been delegated to the extension processing circuitry that have not yet had their results synchronised with the main data processing circuitry, a set of indicators is used which groups pending tasks together into subgroups. Thus, indicator 0 corresponds to pending delegated task IDs #0 and #1; indicator 1 corresponds to pending delegated task IDs #2 and #3; indicator 2 corresponds to pending delegated task IDs #4 and #5; and indicator 3 corresponds to pending delegated task IDs #6 and #7. Accordingly, when a delegated-task-related data processing operation that depends on a data item having an indicator set is to be performed, the corresponding subgroup of pending delegated tasks can be identified from the table of pending delegated tasks 240 and those task are then synchronised and the bit is cleared. This technique limits the additional storage required for the indicator bits, balancing this against the need to synchronise more than the one delegated task that strictly needs synchronising.

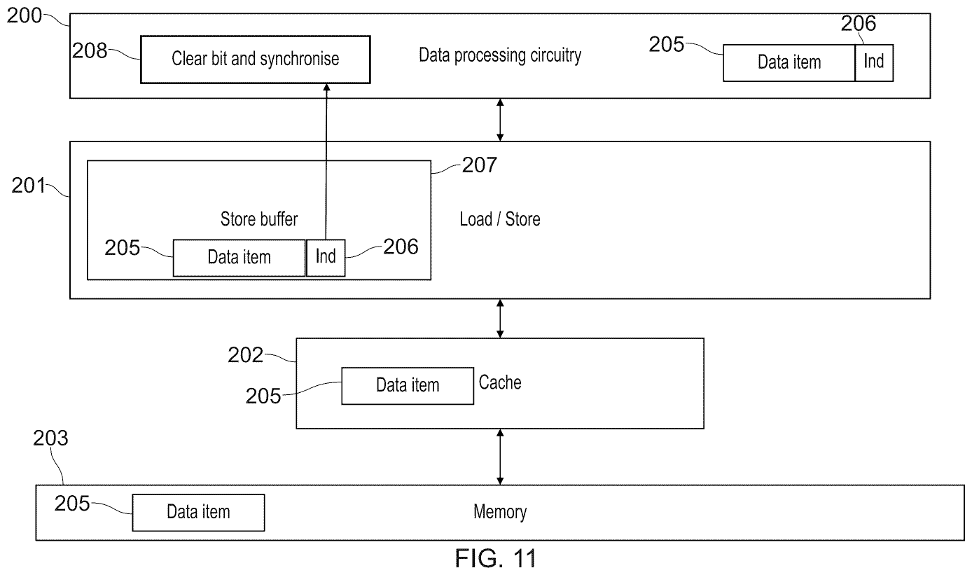

FIG. 11 schematically illustrates a data processing apparatus in accordance with some examples. The apparatus comprises data processing circuitry 200, a load/store unit 201, a data cache 202, and a memory 203. A data value 205 is shown within the data processing circuitry 200 (e.g. held in a register) having an associated indicator 206. The same data item is shown being held in a store buffer 207 of the load/store unit 201 together with its associated indicator 206. The load/store unit represents the limit in this example of the persistence of the indicator value outside the data processing circuitry 200. That is, it can be seen that the same data item 205, when present in the cache 202 or the memory 203 does not have the indicator value 206 associated with it. Hence, for a data value that is to be stored to the memory system (cache 202/memory 203), whilst the data item 205 and its associated indicator 206 can be held in the store buffer 207, but when the value is actually to be transferred to the memory system, this triggers an action 208 to clear the bit and to perform the required synchronisation. Other examples of this propagation limit could also be when the set indicator is propagated up until the data item is consumed by a load or store operation that accesses the data being processed by the extension processing circuitry. In still further examples, if a register value (with a set indicator) is spilled onto the stack, this could also trigger the clearing of the bit and the synchronisation.

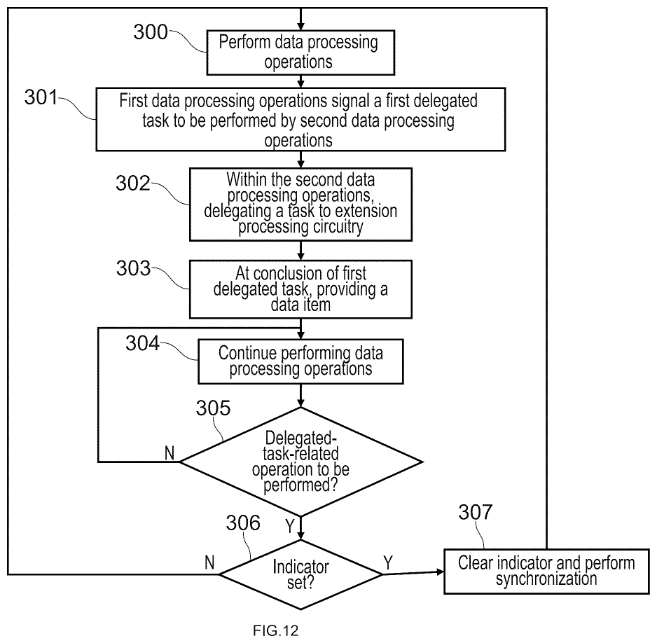

FIG. 12 shows a flow diagram representing a sequence of steps that are taken in accordance with some examples. The flow can be considered to begin at step 300 when data processing circuitry is performing first data processing operations. Then, whilst performing those first data processing operations, at step 301, a signal is generated indicating that a first delegated task is to be performed by second data processing operations (this could for example be a function call, the placing of a token in a task queue, or any other suitable mechanism). The second data processing operations are commenced and at step 302 a task is delegated by the second data processing operations to extension processing circuitry. The extension processing circuitry then (when available to do so) performs the delegated task asynchronously with respect to the data processing circuitry. Meanwhile, at step 303, when the first delegated task (i.e. the second data processing operations) is complete, the second data processing operations provide a data item to the first data processing operations, signalling the conclusion of the first delegated task. The first data processing operations continue (step 304). As the first data processing operations continue, it is monitored (step 305) whether a delegated task-related operation is to be performed. When this is not the case, the first data processing operations continue (step 304). However when such an operation is to be performed (i.e. one that has some dependency on the data item provided at the conclusion of the second data processing operations), then subject to the indicator associated with the data item being set then the flow proceeds via step 307 where the indicator is cleared and the synchronisation is performed. Otherwise, the flow returns to step 300.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

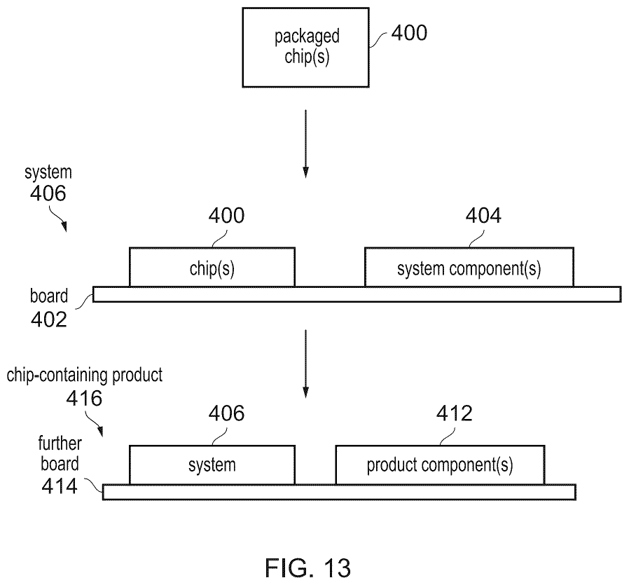

As shown in FIG. 13, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components that are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there are provided apparatuses, methods, systems, chip-containing products and computer-readable storage media. Data processing circuitry performs first data processing operations and second data processing operations. The first data processing operations comprise a first delegation action that signals a first delegated task to be performed by the second data processing operations. Performance of the first delegated task by the second data processing operations comprises a second delegation action, that causes extension processing circuitry to perform a second delegated task asynchronously to the second data processing operations performed by the data processing circuitry. Completion of the first delegated task by the second data processing operations is signalled to the first data processing operations providing a data item with an associated indicator set. The set indicator causes the first data processing operations, when a delegated-task-related data processing operation that depends on the data item is to be performed, to clear the indicator and to perform a synchronization of the data processing circuitry with a result of the second delegated task before performing the delegated-task-related data processing operation.

Various example configurations are set out in the following numbered clauses:

Clause 1. Apparatus comprising:
data processing circuitry configured to perform first data processing operations and second data processing operations,
wherein the first data processing operations comprise a first delegation action, wherein the first delegation action is arranged to signal a first delegated task to be performed by the second data processing operations,
and wherein performance of the first delegated task by the second data processing operations comprises a second delegation action; and
extension processing circuitry associated with the data processing circuitry and configured to perform a second delegated task in response to the second delegation action, wherein the extension processing circuitry is configured to perform the second delegated task asynchronously to the second data processing operations performed by the data processing circuitry,
wherein the second data processing operations are arranged to signal completion of the first delegated task to the first data processing operations and to provide a data item, wherein an indicator associated with the data item is set,
wherein the first data processing operations are arranged, when a delegated-task-related data processing operation that depends on the data item is to be performed, and when the indicator is set, to clear the indicator and to perform a synchronization operation that synchronizes the data processing circuitry with a result of the second delegated task before performing the delegated-task-related data processing operation.

Clause 2. The apparatus of Clause 1, wherein the first delegation action is a call to a function, wherein the second data processing operations are the function, and wherein a return from the function signals the completion of the first delegated task.

Clause 3. The apparatus of Clause 2, wherein the data item is a value returned from the function.

Clause 4. The apparatus of Clause 1, wherein the first delegation action comprises storing an indication of the first delegated task to a data storage structure, and the second data processing operations are arranged to retrieve the indication of the first delegated task from the data storage structure.

Clause 5. The apparatus of Clause 4, wherein the second data processing operations are arranged to store the data item to a further data storage structure.

Clause 6. The apparatus of any preceding Clause, wherein the data processing circuitry, in performing the first data processing operations, is configured to propagate the set indicator in association with resulting data that depends on the data item.

Clause 7. The apparatus of any preceding Clause, wherein the data processing circuitry is configured to perform the first data processing operations in response to a sequence of instructions that define the first data processing operations,
and wherein the data processing circuitry is responsive to a synchronisation instruction to perform the synchronization operation and to clear the indicator.

Clause 8. The apparatus of any of Clauses 1-7, wherein the data processing circuitry is configured to delegate multiple tasks to the extension processing circuitry via multiple sets of second data processing operations,
wherein the data processing circuitry is configured to maintain, for each of the multiple tasks delegated to the extension processing circuitry, a single indicator, such that a completion of a respective first delegated task that delegated a respective task to the extension processing circuitry provides a respective data item, wherein the single indicator associated with the respective data item is set,
and wherein the data processing circuitry is configured, when a respective delegated-task-related data processing operation that depends on the respective data item is to be performed, and when the single indicator is set, to clear the respective indicator and to perform the synchronization operation that synchronizes the data processing circuitry with respective results of all of the multiple tasks delegated to the extension processing circuitry before performing the respective delegated-task-related data processing operation.

Clause 9. The apparatus of any of Clauses 1-7, wherein the data processing circuitry is configured to delegate multiple tasks to the extension processing circuitry via multiple sets of second data processing operations, and the data processing circuitry is configured to maintain a set of indicators,
wherein a completion of a respective first delegated task that delegated a respective task of the multiple tasks to the extension processing circuitry provides a respective data item, wherein a selected indicator of the set of indicators associated with the respective data item is set,
and wherein the data processing circuitry is configured, when a respective delegated-task-related data processing operation that depends on the respective data item is to be performed, and when the selected indicator is set, to clear the selected indicator and to perform the synchronization operation that synchronizes the data processing circuitry with a respective result of the respective task before performing the respective delegated-task-related data processing operation.

Clause 10. The apparatus of Clause 9, wherein a multiplicity of the set of indicators corresponds to a multiplicity of the multiple tasks.

Clause 11. The apparatus of Clause 9, wherein a multiplicity of the set of indicators is less than a multiplicity of the multiple tasks, such that a given indicator of the set of indicators corresponds to more than one of the multiple tasks.

Clause 12. The apparatus of Clause 6, or any of Clauses 7-11 when dependent on Clause 6, wherein the data processing circuitry is configured, when a predetermined type of data processing operation is to be performed, to clear the indicator and to perform the synchronization operation before performing the predetermined type of data processing operation.

Clause 13. The apparatus of Clause 12, wherein the predetermined type of data processing operation comprises storing the data item to a memory location.

Clause 14. The apparatus of Clause 12, wherein the predetermined type of data processing operation comprises a load from or a store to a memory location derived from the data item.

Clause 15. The apparatus of any preceding Clause, wherein the data item provided by the completion of the first delegated task is a pointer to data generated by the second delegated task.

Clause 16. The apparatus of any preceding Clause, wherein the data item provided by the completion of the first delegated task indicates a size of a block of data generated by the second delegated task.

Clause 17. The apparatus of Clause 16, wherein the data processing circuitry is configured to perform the delegated-task-related data processing operation subject to a size-limit threshold condition for the size of the block of data being satisfied,
and the data processing circuitry is configured to propagate the set indicator through a control flow followed when the size-limit threshold condition is satisfied, and to clear the set indicator and to perform the synchronization operation directly prior to performing the delegated-task-related data processing operation.

Clause 18. The apparatus of any preceding Clause, wherein the data processing circuitry is configured to perform the first data processing operations in response to a sequence of instructions that define the first data processing operations, and the data processing circuitry is configured to perform the first data processing operations out-of-order with respect to an ordering of the sequence of instructions,
wherein the data processing circuitry comprises multiple physical rename registers that each can be selectively associated with an individual architectural register, and wherein the data processing circuitry, when the delegated-task-related data processing operation that depends on the data item is to be performed, and when the indicator is set, is configured to clear the indicator in all of the multiple physical rename registers.

Clause 19. The apparatus of Clause 18, wherein the data processing circuitry is responsive to a synchronisation instruction to perform the synchronization operation and to clear the indicator in all of the multiple physical rename registers.

Clause 20. A system comprising:
the apparatus of any preceding Clause, implemented in at least one packaged chip;
at least one system component; and
a board, wherein the at least one packaged chip and the at least one system component are assembled on the board.

Clause 21. A chip-containing product comprising the system of Clause 20, wherein the system is assembled on a further board with at least one other product component.

Clause 22. A method comprising:
performing first data processing operations and second data processing operations in data processing circuitry,
wherein the first data processing operations comprise a first delegation action, wherein the first delegation action is arranged to signal a first delegated task to be performed by the second data processing operations,
and wherein performance of the first delegated task by the second data processing operations comprises a second delegation action;
delegating from the second data processing operations a second delegated task to extension processing circuitry associated with the data processing circuitry;
performing the second delegated task delegated by the second data processing operations in the extension processing circuitry, wherein the extension processing circuitry is configured to perform the second delegated task asynchronously to the second data processing operations performed by the data processing circuitry;
signalling completion of the first delegated task by the second data processing operations to the first data processing operations and providing a data item, wherein an indicator associated with the data item is set; and
in the first data processing operations, when a delegated-task-related data processing operation that depends on the data item is to be performed, and when the indicator is set, clearing the indicator and performing a synchronization operation that synchronizes the data processing circuitry with a result of the second delegated task before performing the delegated-task-related data processing operation.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
data processing circuitry configured to perform first data processing operations and second data processing operations,
wherein the first data processing operations comprise a first delegation action, wherein the first delegation action is arranged to signal a first delegated task to be performed by the second data processing operations,
and wherein performance of the first delegated task by the second data processing operations comprises a second delegation action; and
extension processing circuitry associated with the data processing circuitry and configured to perform a second delegated task in response to the second delegation action, wherein the extension processing circuitry is configured to perform the second delegated task asynchronously to the second data processing operations performed by the data processing circuitry,
wherein the second data processing operations are arranged to signal completion of the first delegated task to the first data processing operations and to provide a data item, wherein an indicator associated with the data item is set,
wherein the first data processing operations are arranged, when a delegated-task-related data processing operation that depends on the data item is to be performed, and when the indicator is set, to clear the indicator and to perform a synchronization operation that synchronizes the data processing circuitry with a result of the second delegated task before performing the delegated-task-related data processing operation.

2. The apparatus of claim 1, wherein the first delegation action is a call to a function, wherein the second data processing operations are the function, and wherein a return from the function signals the completion of the first delegated task.

3. The apparatus of claim 2, wherein the data item is a value returned from the function.

4. The apparatus of claim 1, wherein the first delegation action comprises storing an indication of the first delegated task to a data storage structure, and the second data processing operations are arranged to retrieve the indication of the first delegated task from the data storage structure.

5. The apparatus of claim 4, wherein the second data processing operations are arranged to store the data item to a further data storage structure.

6. The apparatus of claim 1, wherein the data processing circuitry, in performing the first data processing operations, is configured to propagate the set indicator in association with resulting data that depends on the data item.

7. The apparatus of claim 1, wherein the data processing circuitry is configured to perform the first data processing operations in response to a sequence of instructions that define the first data processing operations,
and wherein the data processing circuitry is responsive to a synchronisation instruction to perform the synchronization operation and to clear the indicator.

8. The apparatus of claim 1, wherein the data processing circuitry is configured to delegate multiple tasks to the extension processing circuitry via multiple sets of second data processing operations,
wherein the data processing circuitry is configured to maintain, for each of the multiple tasks delegated to the extension processing circuitry, a single indicator, such that a completion of a respective first delegated task that delegated a respective task to the extension processing circuitry provides a respective data item, wherein the single indicator associated with the respective data item is set,
and wherein the data processing circuitry is configured, when a respective delegated-task-related data processing operation that depends on the respective data item is to be performed, and when the single indicator is set, to clear the respective indicator and to perform the synchronization operation that synchronizes the data processing circuitry with respective results of all of the multiple tasks delegated to the extension processing circuitry before performing the respective delegated-task-related data processing operation.

9. The apparatus of claim 1, wherein the data processing circuitry is configured to delegate multiple tasks to the extension processing circuitry via multiple sets of second data processing operations, and the data processing circuitry is configured to maintain a set of indicators,
wherein a completion of a respective first delegated task that delegated a respective task of the multiple tasks to the extension processing circuitry provides a respective data item, wherein a selected indicator of the set of indicators associated with the respective data item is set,
and wherein the data processing circuitry is configured, when a respective delegated-task-related data processing operation that depends on the respective data item is to be performed, and when the selected indicator is set, to clear the selected indicator and to perform the synchronization operation that synchronizes the data processing circuitry with a respective result of the respective task before performing the respective delegated-task-related data processing operation.

10. The apparatus of claim 9, wherein a multiplicity of the set of indicators corresponds to a multiplicity of the multiple tasks.

11. The apparatus of claim 9, wherein a multiplicity of the set of indicators is less than a multiplicity of the multiple tasks, such that a given indicator of the set of indicators corresponds to more than one of the multiple tasks.

12. The apparatus of claim 6, wherein the data processing circuitry is configured, when a predetermined type of data processing operation is to be performed, to clear the indicator and to perform the synchronization operation before performing the predetermined type of data processing operation.

13. The apparatus of claim 12, wherein the predetermined type of data processing operation comprises storing the data item to a memory location.

14. The apparatus of claim 12, wherein the predetermined type of data processing operation comprises a load from or a store to a memory location derived from the data item.

15. The apparatus of claim 1, wherein the data item provided by the completion of the first delegated task is a pointer to data generated by the second delegated task.

16. The apparatus of claim 1, wherein the data item provided by the completion of the first delegated task indicates a size of a block of data generated by the second delegated task.

17. The apparatus of claim 16, wherein the data processing circuitry is configured to perform the delegated-task-related data processing operation subject to a size-limit threshold condition for the size of the block of data being satisfied,
and the data processing circuitry is configured to propagate the set indicator through a control flow followed when the size-limit threshold condition is satisfied, and to clear the set indicator and to perform the synchronization operation directly prior to performing the delegated-task-related data processing operation.

18. The apparatus of claim 1, wherein the data processing circuitry is configured to perform the first data processing operations in response to a sequence of instructions that define the first data processing operations, and the data processing circuitry is configured to perform the first data processing operations out-of-order with respect to an ordering of the sequence of instructions,
wherein the data processing circuitry comprises multiple physical rename registers that each can be selectively associated with an individual architectural register, and wherein the data processing circuitry, when the delegated-task-related data processing operation that depends on the data item is to be performed, and when the indicator is set, is configured to clear the indicator in all of the multiple physical rename registers.

19. The apparatus of claim 18, wherein the data processing circuitry is responsive to a synchronisation instruction to perform the synchronization operation and to clear the indicator in all of the multiple physical rename registers.

20. A system comprising:
the apparatus of claim 1, implemented in at least one packaged chip;
at least one system component; and
a board, wherein the at least one packaged chip and the at least one system component are assembled on the board.

21. A chip-containing product comprising the system of claim 20, wherein the system is assembled on a further board with at least one other product component.

22. A method comprising:
performing first data processing operations and second data processing operations in data processing circuitry,
wherein the first data processing operations comprise a first delegation action, wherein the first delegation action is arranged to signal a first delegated task to be performed by the second data processing operations,
and wherein performance of the first delegated task by the second data processing operations comprises a second delegation action;
delegating from the second data processing operations a second delegated task to extension processing circuitry associated with the data processing circuitry;
performing the second delegated task delegated by the second data processing operations in the extension processing circuitry, wherein the extension processing circuitry is configured to perform the second delegated task asynchronously to the second data processing operations performed by the data processing circuitry;
signalling completion of the first delegated task by the second data processing operations to the first data processing operations and providing a data item, wherein an indicator associated with the data item is set; and
in the first data processing operations, when a delegated-task-related data processing operation that depends on the data item is to be performed, and when the indicator is set, clearing the indicator and performing a synchronization operation that synchronizes the data processing circuitry with a result of the second delegated task before performing the delegated-task-related data processing operation.
